(19) United States
(12) Patent Application Publication
(10) Pub. No.: US 2018/0319120 A1
(43) Pub. Date: Nov. 8, 2018

(54) METHOD AND PROCESS FOR PROVIDING A STRUCTURAL REINFORCEMENT TO A WATER TANK

(71) Applicant: Antônio Carlos Torres, Vitória (BR)

(72) Inventor: Antônio Carlos Torres, Vitória (BR)

(21) Appl. No.: 15/773,715

(22) PCT Filed: Nov. 7, 2016
(86) PCT No.: PCT/BR2016/050286

§ 371 Date: May 4, 2018

(30) Foreign Application Priority Data
Nov. 6, 2015 (BR) BR10 2015 0280416

(51) Int. Cl. B32B 1/02; B65D 1/42; B32B 27/08

(52) U.S. Cl. CPC B32B 1/02; B29C 41/04; B32B 27/08; B65D 1/42

(57) ABSTRACT

The present invention belongs to the field of devices for storing drinking or non-drinking water, more specifically to water tanks and large capacity water reservoirs, characterized in that a structural reinforcement is provided which withstands greater mechanical loads, in particular on the edges thereof, which loads cause cracks or fissures that damage the entire reservoir in the known prior art models.

### FIELD OF THE INVENTION

The present invention pertains to the field of storage devices for water, drinkable or otherwise, more specifically to water tanks and large capacity reservoirs, standing out from the products known in the state of the art by having a structural reinforcement that enables a higher application of mechanical loads, especially at its edges, which in the models known in the state of the art generate cracks or splits that damage the entire reservoir.

### SUMMARY OF THE INVENTION

Storage tanks for water, drinkable or otherwise, have been known in the state of the art for a long time. They were initially built of cement and asbestos and subsequently began to be made of plastic or other known and suitable polymers. The water tanks or reservoirs known in the state of the art are conceived based on a single body shaped in the geometry required by the application. Tanks are mostly shaped, such that this single part body has tapering means for the outflow of the water or liquid by gravity.

In certain situations, such as, for example, application of the water tank in cisterns or other underground application usually employs water outflow means through electro-mechanical systems, where a pump fed by a water-pressurized electric current, making it overcome gravity and be raised to a higher plane than that of the reservoir. In the water tank made of plastic or polymers, there are sections separated by slants or chamfers that increase the resistance of the body when it receives its maximum load capacity. The single body already cited normally receives a U-shape at its edges for greater resistance to the initial perimeter of the body, such that it can receive a lid having geometry compatible with the body.

In water tanks or reservoirs having the above characteristics, notably the large capacity ones, that is, which store volumes in excess of five thousand liters of water, tend to show damage in the upper portion of the water tank especially where the edge is upside down U-shaped or other known and suitable geometry. Once the water tank or reservoir is in side position, the edge does not withstand the mechanical loads imposed there upon and shows cracks and splits that end up compromising the entire structure of the single body, this condition worsens when this structure is in contact with the ground, where the demand for mechanical resistance is even greater.

Therefore, once the water tank or reservoir is composed of a single body, there is major hardship in aggregating elements that increase the mechanical resistance of the combination, such as, for example, reinforcements or metal frames.

Accordingly, the objective of the present invention is to obtain a method and process for structural reinforcement in water reservoirs that increase the mechanical resistance of the water tank or reservoir, without interfering in the construction of the body.

It is also an objective of the present invention to obtain a method and process for obtaining structural reinforcement in a water reservoir with a view to eliminating splits or cracks, especially in the peripheral portions where there is a higher imposition of mechanical loads.

It is finally an objective of the present invention to obtain a method and process for obtaining structural reinforcement in a water reservoir having competitive construction and costs.

These and other objectives and advantages described above are achieved by the provision of a construction process of a water tank or reservoir wherein its upper marginal portion is endowed with a reinforced edge in order to preventing cracks and splits as already mentioned. This reinforcement in the marginal portion, particularly at the edges, is achieved by way of a rigid component inserted prior to the shaping process of the water tank or reservoir, such that once shaped it is highly resistant to the loads imposed.

The above process results in a much longer useful life of the water tank or reservoir, as well as installation in places with much harsher conditions.

### BRIEF DESCRIPTION OF THE DRAWINGS

The invention will be better described based on the accompanying drawings and figures, provided as examples, wherein:

FIG. 1: detailed perspective view of the tank or reservoir, obtained by way of the method and process for providing a structural reinforcement to a water tank, object of the present invention;

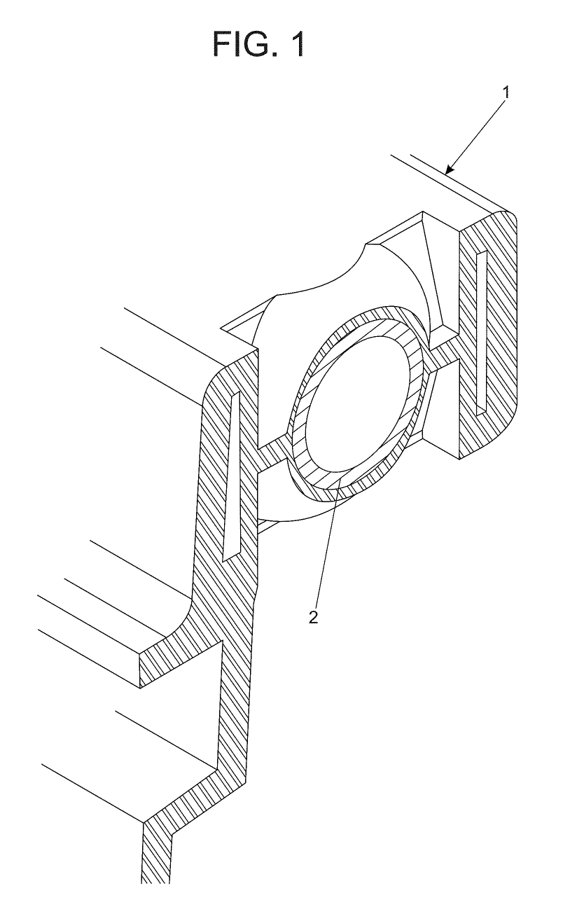

FIG. 2: perspective view of the tank or reservoir obtained by way of the method and process for providing a structural reinforcement to a water tank, object of the present invention;

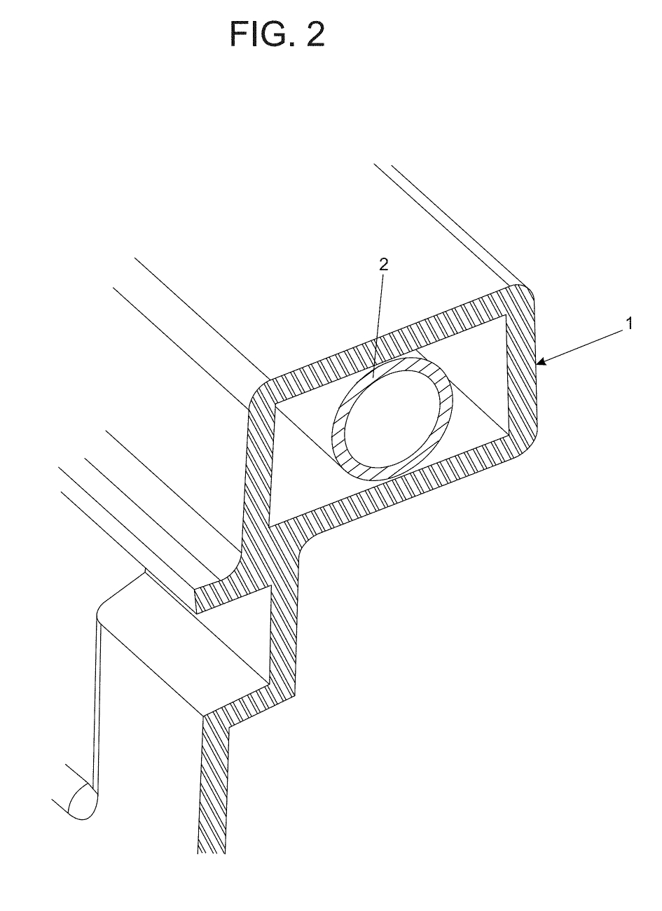

FIG. 3: plan view of the tank or reservoir obtained by way of the method and process for providing a structural reinforcement to a water tank, object of the present invention.

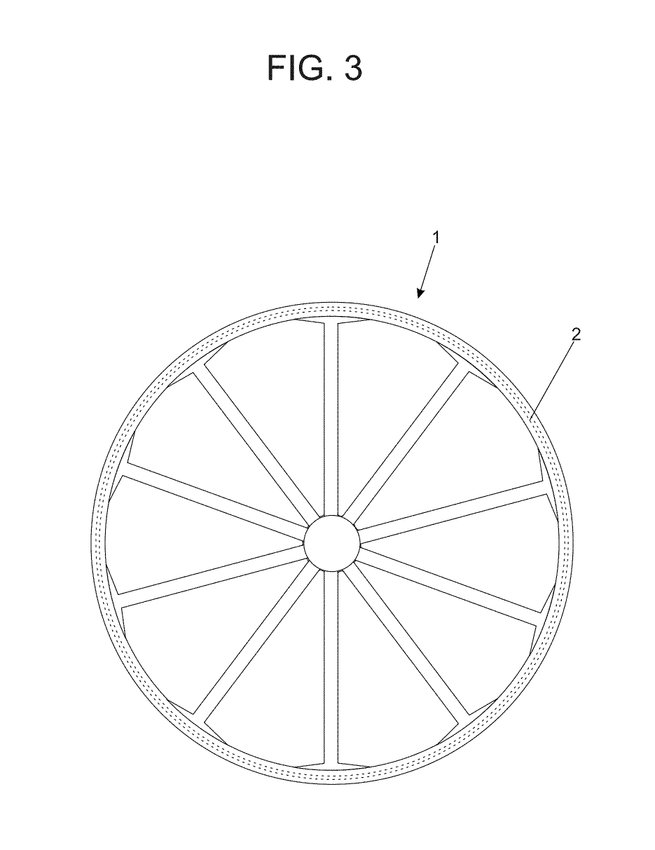

### PREFERRED ARRANGEMENT

As illustrated in the above drawings, the water tank, conventionally obtained by the method and process for providing a structural reinforcement to a water tank (01) is composed of a highly resistant material reinforcement (02) fastened to the edges thereof in a stage prior to shaping, by rotomolding process, with a view to tightening and distributing the loads imposed on the edge.

Having applied this reinforcement (02), which may be a metal alloy, polymers are converted into a highly resistant structure, this structure being disposed in accordance with the geometry of the part to be obtained, and may have a circular or rectangular section or any other geometry that the format of the reservoir body requires. Once the structural reinforcement is disposed, the construction material of the water tank or reservoir (01) is subject to a rotomolding process.

In the rotomolding process, the raw material is placed in a mold, essential supported by a primary shaft and a secondary one, and this mold is operatively associated to a heat source, such that it is simultaneously heated and turned, forcing the particles to deform and melt onto the female mold without the need for applying external pressure or centrifugal force.

In a second stage, the mold is designed to cool, while it turns around the two perpendicular shafts. Cooling is by air currents obtained from a source installed on the equipment itself, preferably a ventilator sized proportionally to the mold, and cooling is completed by jets of water, equally obtained from an external source. Once cooled, the part is withdrawn from the mold already incremented at its marginal portions, more particularly at the edges as a means of reinforcement.

The process of obtaining the water tank, as already described, provides a means of absorbing the loads imposed upon the single body of the tank or reservoir by distributing the loads imposed by the means where it is installed. Further, the process described above provides the structuring of the part by means of reinforcement in the manufacturing process itself, preventing deformation and maintaining the upper diameter of the water tank or reservoir once the polymer has cooled.

Although just one constructive arrangement of the present patent of invention has been illustrated herein, it should be understood that alterations in shape and arrangement can be made in the different stages of the method and process for obtaining structural reinforcement in a water reservoir, without straying from the constructive concept defined in the claims accompanying the present specification, also including a plurality of materials to be disposed as structural reinforcement element.

1. METHOD AND PROCESS FOR PROVIDING A STRUCTURAL REINFORCEMENT TO A WATER TANK, comprising a rotomolding process for obtaining a single body part (01), wherein said part (01), in a stage prior to the rotomolding process, has a structural reinforcement (02) on its marginal portion, more particularly on its edges.

2. METHOD AND PROCESS FOR PROVIDING A STRUCTURAL REINFORCEMENT TO A WATER TANK, according to claim 1, wherein the structural reinforcement (02) is comprised of high resistance material, such as metal alloys, polymers or other known and suitable material that provides absorption of the loads imposed.

3. METHOD AND PROCESS FOR PROVIDING A STRUCTURAL REINFORCEMENT TO A WATER TANK, according to claim 1, wherein the structural reinforcement (02) has a section and geometry adjusted to the format of the single body.
